(19) United States
(12) Patent Application Publication
(10) Pub. No.: US 2014/0185061 A1
(43) Pub. Date: Jul. 3, 2014

(54) METHOD AND SYSTEM FOR IN-LINE REAL-TIME CALCULATION OF THICKNESSES OF SEMICONDUCTOR LAYERS OF A PHOTOVOLTAIC DEVICE

(71) Applicant: FIRST SOLAR, INC, Perrysburg, OH (US)

(72) Inventors: Benyamin Buller, Sylvania, OH (US); David Hwang, Perrysburg, OH (US); Benjamin Milliron, Toledo, OH (US); Dale Roberts, Temperance, MI (US); Rui Shao, Sylvania, OH (US); Zhibo Zhao, Novi, MI (US)

(73) Assignee: FIRST SOLAR, INC, Perrysburg, OH (US)

(21) Appl. No.: 14/133,916

(22) Filed: Dec. 19, 2013

Related U.S. Application Data
(60) Provisional application No. 61/746,379, filed on Dec. 27, 2012.

(51) Int. Cl. G01B 11/06

(52) U.S. Cl. CPC G01B 11/0616; G01B 11/0625
USPC 356/632; 356/630; 118/712; 118/697

(57) ABSTRACT

A method and system for real-time, in-line measurements of thicknesses of semiconductor layers of photovoltaic devices is provided. The method and system include taking ex-situ optical data measurements after deposition of the semiconductor layers. The measurements are then used to calculate the thicknesses of the layers in real-time using optical modeling software.

### CROSS-REFERENCE TO RELATED APPLICATION

This application claims priority to U.S. Provisional Application No. 61/746,379, filed Dec. 27, 2012, which is hereby fully incorporated by reference.

### FIELD OF THE INVENTION

The disclosed embodiments relate generally to photovoltaic devices, and more particularly, to a system and method of calculating, in real-time, thicknesses of the semiconductor layers of photovoltaic devices.

### BACKGROUND OF THE INVENTION

A variety of thin film photovoltaic devices, such as cells and modules, are known. During fabrication of such devices, layers of semiconductor material are commonly formed on a transparent conductive oxide (TCO) stack, which is used as a contact for the devices. The semiconductor layers commonly include one layer serving as a window layer and a second layer serving as an absorber layer. The absorber layer is often made of a p-type semiconductor material and the window layer of an n-type semiconductor material and the point at which they meet forms a p-n junction where light is converted to electricity. Because the semiconductor layers are crucial to the conversion of light to electricity, these layers could be considered as the most important components in a photovoltaic device.

The thicknesses of the semiconductor layers can have a substantial impact on device performance. For example, a thinner semiconductor window layer allows greater penetration of the shorter wavelengths of incident light to absorber layer. To ensure a consistent performance across devices or batches of devices, the thickness of the semiconductor layers should be consistent from one device to another. To do so, the thickness of each of the individual semiconductor layers in the photovoltaic device should be controlled as the devices are being formed. To control the thicknesses of the layers as the device is being formed, the thicknesses of the layers should be measured in real-time (i.e., as the layers are being formed) or near real-time. Presently, there is not a method for accurately measuring the thicknesses of the semiconductor layers as the devices are being formed.

One method that has been used previously to determine the thicknesses of the individual semiconductor layers is to take microscopic cross-sectional measurements of the layers of the device after fabrication. To take such measurements, a previously-fabricated device is cut open to expose its cross-sectional layers and an electron microscope (or other microscopic measurement tool) is used to measure the thickness of the exposed semiconductor layers. To ensure that the thicknesses of the semiconductor layers do not deviate too much from one device to another, the microscopic cross-sectional measurements should be taken on a fairly regular basis. Doing so, however, may slow down the manufacturing line as layer deposition may have to be stopped awaiting the results of the measurements to determine whether adjustments to the deposition equipment are needed. Further, since the device is destroyed in order to take the measurements, additional costs may be added to the final cost of the photovoltaic devices.

Hence, a non-destructive method for measuring the semiconductor layer thicknesses is preferable. Presently, two separate methods must be used to determine the thicknesses of the semiconductor window and absorber layers. Semiconductor window layer thickness is determined using LED sensors and semiconductor absorber layer thickness is determined using a beta backscattering method.

To determine the semiconductor window layer thickness using LED sensors. Specifically, an LED provides a light source (at a single wavelength, e.g., 400 nm) which is directed toward a top surface of a substrate with the TCO stack and semiconductor window layer deposited thereon and optical data, with respect to the light that is transmitted through the layers of the substrate with the TCO stack and semiconductor window layer deposited thereon, is collected through sensor windows. This optical transmission data is used to calculate the semiconductor window layer thickness. In general, for a semiconductor window layer formed of CdS, the intensity of the transmitted light decreases exponentially with an increase in window layer thickness. There is a perfect correlation between CdS thickness and intensity of the transmitted light without the substrate and TCO stack; however, the substrate and TCO stack cause some reflection of the light to occur as well. This reflection affects the intensity of the transmitted light. Generally, when using this method for calculating the thickness of the semiconductor window layer, it is assumed that the TCO layer or stack, upon which the semiconductor window layer is deposited, will always have the same thickness and optical properties from device to device. However, inevitable manufacturing variations in the thickness and optical properties of the TCO stack, e.g., from device to device, will cause variations in the reflection caused by the TCO stack. As stated, this will affect the measured intensity of the transmitted light that is used to calculate the thickness of the semiconductor window layer. Thus, the assumption that the thickness and optical properties of the TCO layer or stack is always the same, introduces error into using this method for calculating the semiconductor layer thickness.

Another assumption upon which this calculation of the semiconductor window layer thickness is based is that the optical properties of the TCO layer or stack will remain constant during the deposition of the semiconductor window layer itself, a process which generally involves high temperatures. It is well known that, due to the high temperatures used, the optical properties of the TCO stack do not remain the same from device to device. As noted, differences in the optical properties of the TCO stack will cause variations in the reflection caused thereby during the measurement. Therefore, this assumption that the optical properties of the TCO stack do not change, can introduce additional inaccuracies in the thickness calculation that is based on the optical data collected by the sensors (e.g., intensity of the transmitted light).

Further, overspray of the CdS vapor from the semiconductor window deposition process onto the backside of the substrate and accumulation of the CdS vapor on the sensor windows over time can both also affect the measurements taken by the sensors. Since the light must travel through additional CdS material that is not part of the semiconductor window layer, the calculation of the thickness of the semiconductor window layer based on the intensity of the transmitted light can be further skewed. Therefore, it would be desirable to determine semiconductor window layer thickness more accurately.

Regarding the semiconductor absorber layer, as mentioned above, a beta backscattering method can be used to determine the thickness thereof. In this method, beta electrons are impinged on the surface of the device and the number of electrons that are backscattered (reflected) is measured. This number of reflected electrons directly relates to the thickness of the absorber layer; thus, by measuring this number of reflected electrons, the thickness of the absorber layer can be determined. However, this measurement is made off-line. It would therefore be desirable to perform semiconductor absorber layer thickness measurements in real-time. Real-time measurements may allow, for example, for real-time correction of undesired manufacturing variances.

Thus, a method for rapid, more accurate, in-line, and real-time determination of thicknesses of both the semiconductor window layer and the semiconductor absorber layer of photovoltaic devices is needed.

### BRIEF DESCRIPTION OF THE DRAWINGS

FIG. 1 is a schematic representation of a photovoltaic device.

FIG. 2 is a schematic representation of a deposition system for growing semiconductor layers having an in-line measurement system, in accordance with a disclosed embodiment.

FIGS. 3A, 3B and 3C are a schematic representation of an ex-situ measurement system, in accordance with a disclosed embodiment.

FIG. 4 is a schematic representation of a computer system including an optical modeling software package, in accordance with a disclosed embodiment.

FIG. 5 is a flowchart showing a general method of operation of a portion of a photovoltaic device production system, in accordance with a disclosed embodiment.

FIGS. 6A and 6B, respectively, show sample reflection and transmission curves.

### DETAILED DESCRIPTION OF THE INVENTION

In the following detailed description, reference is made to the accompanying drawings which form a part hereof, and in which is shown by way of illustration specific embodiments that may be practiced. These embodiments are described in sufficient detail to enable those skilled in the art to make and use them, and it is to be understood that structural, logical, or procedural changes may be made to the specific embodiments disclosed without departing from the spirit and scope of the invention.

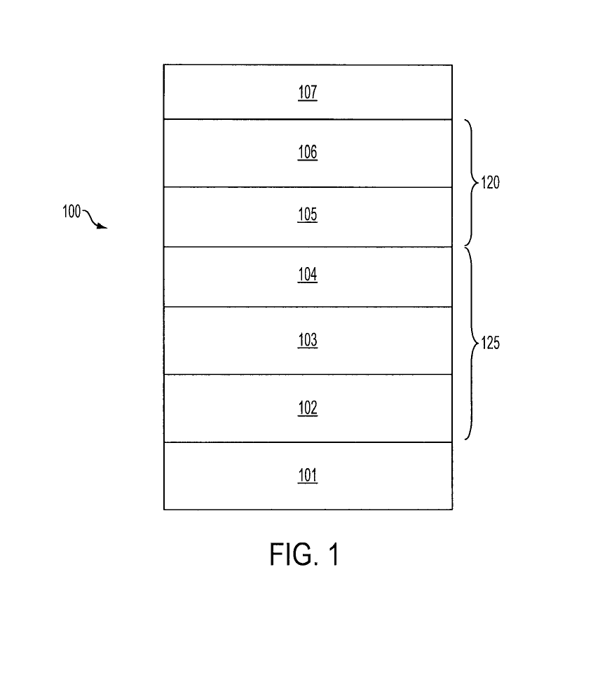

Referring to the figures, FIG. 1 shows one example of a general structure of a photovoltaic (PV) device 100. The photovoltaic device 100 includes a TCO stack 125 formed over substrate 101. The TCO stack 125 may include a barrier layer 102, a TCO layer 103 and a buffer layer 104. The photovoltaic device also includes semiconductor layer(s) 120 which include a semiconductor window layer 105 formed adjacent a semiconductor absorber layer 106. A back contact (electrode) 107 can be formed adjacent to semiconductor layer(s) 120. Some PV devices may include a back cover (not shown) deposited over the back contact 107.

The substrate 101 and the back cover are used to protect the PV device 100 against environmental hazards. Since incident light has to go through the substrate 101 to reach the semiconductor(s) 120 where it is converted to electricity, the substrate 101 needs to be optically transparent. Therefore, the substrate 101 may be made of glass such as soda-lime glass. For aesthetic purposes, the back cover may also be made of glass or may be made of other materials.

Barrier layer 102 is used to lessen sodium diffusion to other layers in the device. Specifically during fabrication and while in operation, the device may be subjected to high temperatures. The high temperatures may disassociate sodium atoms from other atoms in the glass. These disassociated sodium atoms may become mobile ions and may diffuse into other layers of the device. Diffusion of sodium ions in the TCO layer 103 may adversely affect the TCO layer's optical and electrical properties which may lead to deteriorating performance of the device 100. Likewise, diffusion of sodium ions in the semiconductor layers 120 may adversely affect device efficiency. Hence, the barrier layer 102 is used to reduce diffusion of sodium ions to those layers. A variety of materials may be used for the barrier layer 102, such as a silicon nitride, silicon oxide, aluminum-doped silicon oxide, boron-doped silicon nitride, phosphorus-doped silicon nitride, silicon oxide-nitride, or any combination or alloy thereof. Barrier layer 102 may also include a bi-layer of a silicon oxide deposited over a silicon nitride (or an aluminum-doped silicon nitride).

The TCO layer 103 and the back contact 107 serve as electrodes through which the electricity generated by the PV device 100 may be provided externally. The TCO 103, just as in the case of the substrate 101, needs to let light therethrough and therefore can be made of a transparent conductive material such as cadmium stannate, aluminum doped zinc oxide, or tin oxide doped with fluorine. In the present embodiment, the TCO 103 may be made of cadmium stannate as it exhibits high optical transmission and low electrical sheet resistance. The back contact 107 does not have any transparency requirement and thus may be made of a metal such as Mo, Al, Cu, Ag, Au, or a combination thereof.

Buffer layer 104 can facilitate proper deposition of the semiconductor window layer(s) 120. The buffer layer 104 is used to provide a smooth surface on which the semiconductor layer(s) 120 are formed. Certain deposition systems that may be used to deposit the TCO layer 103 may provide a TCO layer 103 with a rather rough surface. In such instances, if a thin window layer 105 were to be formed over the rough TCO layer 103, there might be some discontinuities in the window layer 105, which may decrease the device's performance. To avoid such discontinuities, the buffer layer 104 may be provided between the rough TCO layer 103 and the window layer 105. The buffer layer 104 can include various suitable materials, including tin oxide (e.g., tin (IV) oxide), zinc tin oxide, zinc oxide, zinc magnesium oxide, and zinc oxysulfide.

Semiconductor layer(s) 120 can be deposited on TCO stack 125 and can include any suitable semiconductor layer(s), including, for example a semiconductor bi-layer. The semiconductor bi-layer may include an n-type semiconductor window layer 105 in close proximity to a p-type semiconductor absorber layer 106 to form a p-n junction where solar energy may be converted to electricity. The p-type semiconductor absorber layer 106 may be made of cadmium telluride. Alternatively, the p-type semiconductor layer may be made of copper-indium-gallium-selenium (CIGS) material. The n-type semiconductor window layer 105 may be made of cadmium sulfide. The window layer 105 allows the solar energy to penetrate through to the absorber layer 106. The n- and p-type semiconductor layer(s) 120 can also be of any Group II-VI, III-V or IV semiconductor, such as, for example, ZnO, ZnS, ZnSe, ZnTe, CdO, CdS, CdSe, CdTe, MgO, MgS, MgSe, MgTe, HgO, HgS, HgSe, HgTe, MnO, MnS, MnTe, AN, AlP, AlAs, AlSb, GaN, GaP, GaAs, GaSb, InN, InP, InAs, InSb, TlN, TlP, TlAs, TlSb, or mixtures or alloys thereof.

Note that each of these layers may be composed of more than one layer or film. Additionally, each layer can cover all or a portion of the device and/or all or a portion of the layer or substrate underlying the layer. For example, a “layer” can mean any amount of material that contacts all or a portion of a surface. Each of the layers can be deposited using any known deposition technique, including, but not limited to, sputtering, closed space sublimation (CSS), and vapor transport deposition (VTD), among others. These deposition techniques are well known in the industry and will not herein be described.

As previously discussed, the properties of the semiconductor layer(s) 120, especially the thickness thereof, can directly affect the performance of the photovoltaic device 100. For example, if the thickness of the semiconductor window layer 105 is too thin, fluxing of the window layer material (e.g., intermixing of the window and absorber layer materials during device processing) may occur, thus degrading or destroying the window layer, leading to degradation in device performance. On the other hand, since the material forming the semiconductor window layer 105 is not completely transparent to light (e.g., it absorbs some of the light, thus preventing it from getting to the absorber layer), if the semiconductor window layer 105 is too thick, the available light for photon harvesting at the absorber layer is reduced, thereby reducing photovoltaic efficiency. Thus, a controlled deposition of the semiconductor layer(s) 120 is desired in order to consistently achieve production of devices 100 having the desired efficiency.

Disclosed embodiments provide an in-line measurement system to provide detailed information in real-time about the thicknesses of the deposited semiconductor layer(s) 120. This is accomplished with the use of a multistage semiconductor coater that is equipped with an ex-situ optical measurement system that takes measurements just after the deposition of the semiconductor layer(s) 120. Optionally, another ex-situ optical measurement system may take measurements of the TCO stack 125 just before the deposition of the semiconductor layer(s) 120. Disclosed embodiments also include modeling software which uses the optical measurements taken by the optical measurement system(s) to calculate the thicknesses of each of the semiconductor window layer 105 and semiconductor absorber layer 106. The modeling software may also calculate information with respect to the thickness and/or opto-electronic properties of the layers of the TCO stack 125 to be used in the calculation of the thickness of the semiconductor layer(s) 120. These calculations are achieved in-line and essentially in real-time during device 100 production.

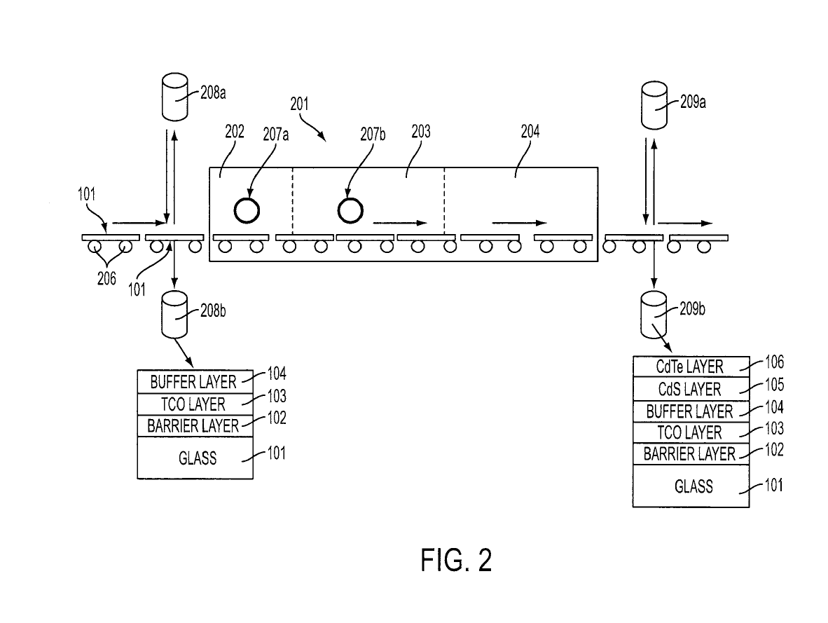

FIG. 2 is a schematic representation of a production device for forming the semiconductor layer(s) 120 in accordance with disclosed embodiments. As seen in FIG. 2, the production device includes a substrate coater 201, which includes multiple heated stages 202, 203 for deposition of the semiconductor window and absorber layers 105, 106, respectively, and cooling chamber 204. The coater 201 may be, for example, a vacuum transport deposition (VTD) coater or any other type of suitable coater for depositing semiconductor material layers. A series of substrates 101 onto which the TCO stack 125 has already been deposited, are conveyed into, through, and out of coater 201 by a conveyor system which may be formed by a series of rollers 206. These rollers 206 move the substrates 101 through the coater 201 at controlled traverse speeds. Each of stages 202, 203 includes a semiconductor material source 207, for example, CdS source 207a and CdTe source 207b shown in FIG. 2, for forming the respective semiconductor window and absorber layers 105, 106 on the substrate 101. In the embodiment of FIG. 2, the semiconductor window layer 105 is applied to the buffer layer 104 in stage 202, the semiconductor absorber layer 106 is applied to the semiconductor window layer 105 in stage 203 and the device stack is cooled in cooling chamber 204 before exiting the coater 201.

The production line device includes ex-situ optical measurement systems 208, 209 located at positions before and after the coater 201, that enable the acquisition of optical data (e.g., reflection and/or transmission data, as discussed below) that may be used to calculate the thicknesses of the absorber and window layers 106 and 105. Alternatively, only ex-situ measurement system 109 may be included. The ex-situ optical measurement system 208 acquires optical data with respect to the TCO stack 125 before a substrate 101 enters the coater 201. The ex-situ optical measurement system 209 acquires optical data with respect to newly-deposited semiconductor layers(s) 120 after a substrate 101 exits the coater 201. Since the optical measurement systems 208, 209 are outside of coater 201, they do not have the problem of accumulation of contaminants, as seen with currently used LED measurement methods.

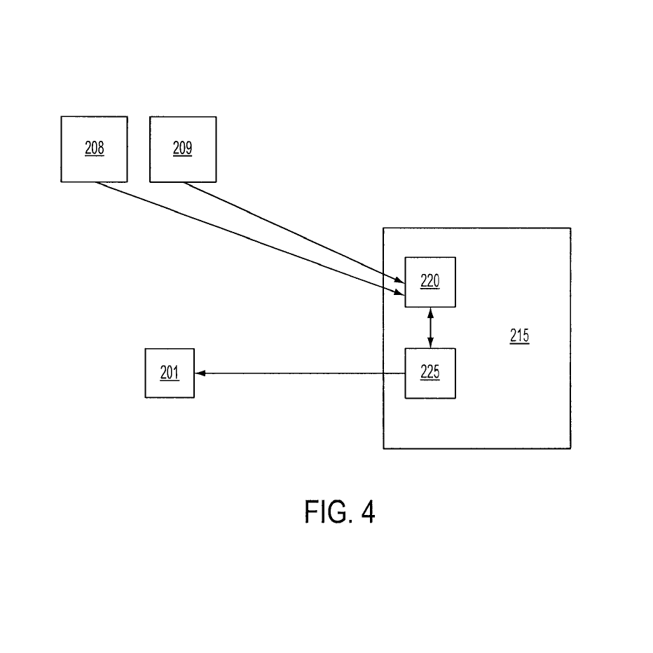

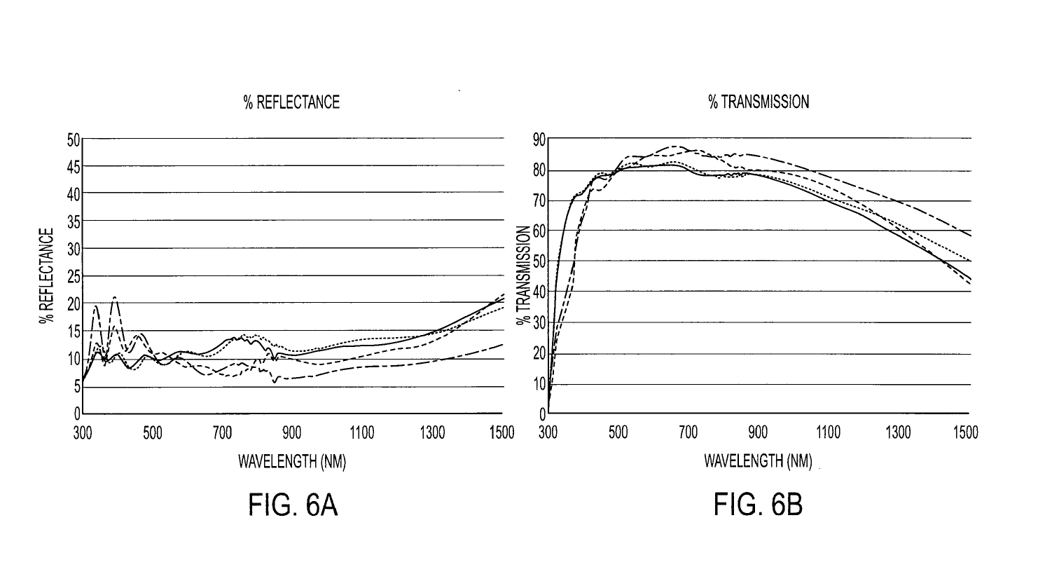

Each optical measurement system 208, 209 includes a pair of sensors 208a/b, 209a/b, respectively, positioned above and below the substrate 101. The sensors 208a/b, 209a/b may be, for example, optical sensors of a photometry optical measurement system. As seen in FIG. 2, sensors 208a, 209a are disposed facing the side of the substrate 101 upon which layers are being deposited and sensors 208b, 209b are disposed on the other side of the substrate 101. Also located near, or as part of, sensors 208a, 209a is a light source. The optical measurement systems 208, 209 illuminate the substrate 101 with a light beam from the light source of known intensity, I₀. Part of this light will be reflected from the surface of the substrate 101 with an intensity I_{R}, part of this light will be transmitted through the substrate 101 with an intensity I_{T} and the remainder is absorbed I_{A}. Assuming there is no scattering, conservation of energy requires that I₀=I_{R}+I_{T}+I_{A}. Measured reflection data (I_{R}) from the coated surface of the substrate 101 is acquired from sensors 208a, 209a and measured transmission data (I_{T}) from light transmitted through the coated substrate 101 is acquired from sensors 208b, 209b. The optical measurement systems 208, 209 use this measured data, in conjunction with the known intensity of light from the light source (I₀), to output reflection curves (R=I_{R}/I₀*100%) and/or transmission curves (T=I_{T}/I₀*100%) over a range of wavelengths (e.g., 200 nm to 1400 nm; 400 nm to 1200 nm). FIGS. 6A and 6B, respectively, show sample reflection and transmission curves. In FIGS. 6A and 6B, multiple exemplary curves are plotted in each chart—each of the curves shown represents reflection or transmission measurement, respectively, for a single substrate. The measured reflection and/or transmission curves are used as inputs into an optical modeling software package 220 (FIG. 4), the implementation of which is described in more detail below.

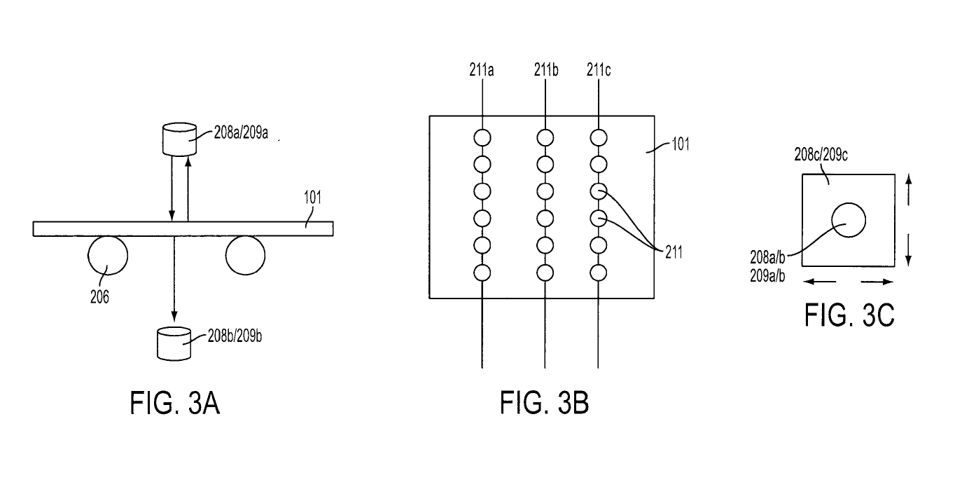

As illustrated in FIGS. 3A, 3B and 3C, the ex-situ optical measurement system sensors 208a/b, 209a/b may be placed on movable x-y stages 208c, 209c (top view seen in FIG. 3C), thereby making the ex-situ optical measurement systems 208, 209 capable of taking optical data at multiple positions 211 with respect to the substrate 101. One method by which this may be done is by performing multiple line scans (e.g., lines 211a, 211b, 211c) with multiple data points being taken at various positions 211 along each line. By using optical data at multiple positions 211 along the substrate 101, two-dimensional mapping of the TCO stack 125 and semiconductor layer(s) 120 may be obtained. This two-dimensional mapping allows for the measurement and detection of spatial variations or non-uniformity of the TCO stack 125 and/or the semiconductor layer(s) 120. For example, variations in layer thickness of the TCO stack 125 or the semiconductor layer(s) 120 at different positions on the substrate 101 may be detected in this manner.

In other exemplary embodiments, variations of the described system may be provided. For example, ex-situ optical measurement system 208, 209 may be movable only in a direction perpendicular to the movement direction of the substrates 101, with collection of data along each of respective lines 211a, 211b, 211c happening as the coated substrate 101 moves along the rollers 206 in relation to the measurement system 208, 209.

Referring to FIG. 4, an exemplary embodiment of the optical modeling software package 220 is now described in more detail. The optical modeling software package 220 is implemented on a computer system 215 that is in communication with at least the optical measurement systems 208, 209. The optical modeling software package 220 receives the optical data (measured transmission and/or reflection curves) acquired by the optical measurement systems 208, 209.

In one exemplary embodiment, the optical modeling software package 220 calculates the thickness for each of the semiconductor layer(s) 120 as the semiconductor layer(s) 120 are formed. In one embodiment, optical modeling software package 220 uses the optical data (measured transmission and/or reflection curves) acquired by the optical measurement system 209 as an input. Other inputs to the optical modeling software package 220 include target thicknesses and optical constant values (e.g., refractive index, extinction coefficient) of each of the semiconductor layer(s) 120. The target thicknesses may be input as the ideal, desired thickness values for each layer. This “desired” thickness is based on design parameters of the device. The inputs to the optical modeling software package 220 may also include target thicknesses and optical constants values for TCO layer 103 and buffer layer 104 and known or pre-determined values for the thicknesses and optical constant values for the substrate 101 and barrier layer 102.

The actual thicknesses of each of the semiconductor layer(s) 120 (and the other layers in the stack) will likely vary from the initial target values that are input to the optical modeling software package 220 (e.g., the desired thickness). This variance is due to, for example, manufacturing variances. Using an imbedded optical model (which is stored as part of the optical modeling software package 220), a modeling analysis is performed (in-line and in a quasi-real time fashion) to calculate the thicknesses of each of the as-deposited semiconductor layer(s) 120. The optical model uses the transmission and/or reflection data collected from the optical measurement systems 208, 209, along with the other inputs to the optical modeling software package discussed above (e.g., target thicknesses and the properties of the layers of the TCO stack 125) to calculate the actual thicknesses of the semiconductor window layer 105 and semiconductor absorber layer 106. The optical model may also calculate the thicknesses and optical constant values for the other layers in the stack, since, as described above, the thickness and properties of each of the layers of the stack affects the overall reflection and transmission data.

The specifics of the imbedded optical model are based on the particular coating design; however a non-limiting example of how the optical model handles this calculation is now described. As noted above, the optical measurement system 209 generates measured reflection (R) and/or transmission (T) curve(s) for a glass substrate 100 over a range of wavelengths, as shown for example in FIGS. 6A and 6B. The range of wavelengths may be, for example, 200 nm to 1400 nm or 400 nm to 1200 nm. Measurements may be taken, for example, at 1 nm increments, or even finer increments depending on the processor capabilities of the system.

As an example, a description of how the thicknesses for the semiconductor layer(s) 120 are determined, using data from only optical measurement system 209, is now described in more detail. Optical measurement system 209 acquires optical data of the stack that includes glass substrate 101/TCO stack 125/semiconductor layer(s) 120. The optical data acquired by optical measurement system 209 consists of a single transmission curve and a single reflection curve, along the range of wavelengths. The transmission and reflection data that is collected by the optical measurement system 209 is affected by the properties of each of the individual layers of the stack, as well as the interfaces between the layers (e.g., the light may go through the semiconductor layer(s), but reflect at the interface between the window layer 105 and TCO stack 125, or may go through the absorber layer 106 and reflect at the interface between the absorber layer 106 and the window layer 105). As long as the optical properties of adjacent layers are sufficiently different from each other, the transmission/reflection curves can be used by the imbedded optical model to calculate properties of each layer in the stack.

The basic principle of determining the unknown values is based on the known properties of transmission of electromagnetic waves in multiple layers of materials. There are many well-developed and well-known methods of using measurements of reflection and transmission data to yield the unknown values of film properties, such as thickness, refractive index and extinction coefficient. Specifics of these methods are described in many textbooks relating to physics, generally, or to properties of thin films, more specifically. One such textbook is, for example, O. S. Heavens, OPTICAL PROPERTIES OF THIN SOLID FILMS, Dover Publications, Inc., New York, N.Y. (1991) (originally published in 1955). As indicated in this text, “explicit, single expressions for the reflectance and transmittance of systems of many films are cumbersome and of no great use.” Many methods for solving for the unknowns in a multi-layer thin-film system are described therein (e.g., Schopper's method, Male's method) and the textbook (which includes these descriptions) is incorporated by reference herein. The optical modeling software uses these known relationships between transmission/reflection and stack properties, in order to generate simulated R and/or T curves, using the inputted target thicknesses and optical constant values of the layers of the stack as a starting point. The optical modeling software can be any commercially available optical simulation software package that is typically used for thin film analysis. Examples of such software packages include OptiLayer's OptiRE software package, W. Theiss Hard- and Software's BREIN software package, and Software Spectra, Inc.'s TFCalc software package. The optical modeling software generates a simulated R and/or T curve, over the same range of wavelengths used for the measured curves. The simulated curves are also similar to those shown in FIGS. 6A and 6B.

The optical modeling software systematically varies the value of each of the properties being calculated (e.g., thickness and optical constant values for each of the semiconductor layer(s) 120 and thickness and optical constant values for each of the layers of the TCO stack 125, in this example) from the original input target values of thickness and optical properties. Several sets of simulated T and R curves are generated using the systematically varied values. For both the T and R curves, each of the several simulated curves is compared to the corresponding (T or R) measured curve. Differences between the simulated curves and the measured curve are calculated and this calculated difference between the simulated and measured curves is minimized to find which simulated curve most closely matches the measured curve. The values of the properties being calculated that correspond to the best fitting curve are determined to be the values of these properties for the as-deposited layers.

The difference between each simulated curve and the measured curve is calculated by finding the T (or R) value at specific wavelengths along each of these two curves, determining an absolute value of the difference between these two values, and summing these absolute values. For example, a pair of T (or R) values (e.g., simulated and measured) can be found for six wavelengths along the range of wavelengths on the curves, subtracting each of these pairs of values to determine an absolute value of the difference between them, and adding these six absolute value numbers together to get a representative difference value to describe the difference between the simulated curve and the measured curve. The difference between the simulated and measured curves is minimized by selecting the simulated curve that results in the lowest representative difference value. In another example, the simulated/measured curve pairs are subtracted, this value is squared, and then the sum of all these squared differences is the representative difference value. The simulated curve which provides the lowest representative difference value when compared to the measured curve is the best-fitting curve with respect to the measured curve from sensor 209.

The final outputs from the modeling software will be the set of the systematically varied input values for the properties being calculated (e.g., thickness and optical constant values for the layers of the TCO stack 125 and the semiconductor layer(s) 120, originally based on the input target thickness and optical property values) that corresponds to the simulated curve that is determined to be the best-fitting curve with respect to the measured curve from sensor 209. These output values from the best-fitting curve provide the calculated value of thickness of each as-deposited layer and the calculated optical constant value of each of the as-deposited layers, based on the measured optical data.

For each substrate 101, the outputs of the modeling analyses include calculated thicknesses of the semiconductor window layer 105 and the semiconductor absorber layer 106. Outputs of the modeling analyses may also include the optical constant values of the semiconductor layer(s) 120, thicknesses of each layer of the TCO stack 125 and post-semiconductor deposition optical constant values (e.g., refractive index, extinction coefficient) of each layer of the TCO stack 125; alternatively, these values may not be output, but are determined merely for use in the calculation of the thicknesses of the semiconductor layer(s) 120. Additionally, outputs may include a statistical analysis for the two-dimensional mapping completed by the ex-situ optical measurement system 209. The modeling analysis outputs may also indicate temporal variations of any of these individual outputs between and among substrates 101, by flagging for the operator when differences occur between, for example, window (or absorber) layer thicknesses, among different substrates 101 exiting the coater 201. The results of the optical modeling may be automatically displayed to an operator or may be stored in computer system 215. Calculations for each coated substrate 101 are commenced by the optical modeling software package 220 after receiving the optical data relating to the substrate from the optical measurement system 208, and are complete before the next coated substrate 101 exits the coater 201.

In another embodiment, the optical modeling software package 220 calculates the thickness for each of the semiconductor layer(s) 120 using the optical data (measured transmission and/or reflection curves) acquired by both optical measurement systems 208, 209 as inputs. In this embodiment, other inputs and the general method of calculation of the layer thicknesses and optical constant values remains the same. However, using the two sets of data collected before and after deposition of the semiconductor layer(s) 120 respectively, may allow for improved reliability of the modeled results.

In yet another embodiment, the values for the thicknesses and optical constants of the layers of the TCO stack 125 prior to the deposition of the semiconductor layer(s) 120 may be known, for example, by being calculated by a separate measurement system, such as that disclosed in co-pending application Ser. No. ______ (attorney docket F4500.1261, entitled METHOD AND SYSTEM FOR IN-LINE REAL-TIME MEASUREMENTS OF LAYERS OF MULTILAYERED FRONT CONTACTS OF PHOTOVOLTAIC DEVICES AND CALCULATION OF OPTO-ELECTRONIC PROPERTIES AND LAYER THICKNESSES THEREOF), filed concurrently herewith, the disclosure of which is incorporated by reference herein. These known values may be provided as input values to the modeling software package 220. In this instance, even greater reliability of calculation of the thicknesses of the semiconductor layer(s) 120 may be achieved. Additionally, this may provide for faster calculation of the unknown values.

In a full production line for photovoltaic devices, the optical measurement system 208 of the disclosed embodiments may be the same as ex-situ optical measurement system located after the multistage coater in which the TCO stack is deposited, as described in the '______ application (attorney docket F4500.1261). In this exemplary embodiment, the optical modeling software package 220 may perform a combined analysis, determining the thicknesses and optical constant values (e.g., refractive index, extinction coefficient) for all layers of the stack (e.g., TCO layer 103, buffer layer 104, semiconductor window layer 105 and semiconductor absorber layer 106) at the same time. In this instance, the optical data from both optical measurement systems 208, 209 is used in the modeling analysis.

The computer system 215 may also include a controller 225 in communication with the coater 201, including rollers 206 and the deposition system of each stage 202, 203. The modeling analysis output may be used for both monitoring and controlling the deposition conditions for the semiconductor window and absorber layers 105, 106. For example, if the determined thickness of either of the semiconductor window layer 105 and/or semiconductor absorber layer 106 is not at desired values, the controller 225 may signal the deposition system of the respective stage 202, 203 to cause a change in the deposition conditions. For example, if the result of the modeling shows that the semiconductor window layer 105 has, e.g., a thickness value outside of an acceptable range (e.g., beyond +/−5% of the desired thickness), then the controller will change the deposition conditions for zone 202 (in which the semiconductor window layer 105 is formed) for forming the semiconductor window layer 105 on subsequent substrates of the production. In a vapor transport deposition, this may include, for example, a change in the flow rate of the carrier gas/CdS supply to bring the thickness back within the desired range. Adjusting the conveyor speed may also be used as a means to adjust the thickness of a layer, but the conveyor speed is generally kept constant for multi-layer production to avoid affecting the thickness of other layers in the stack.

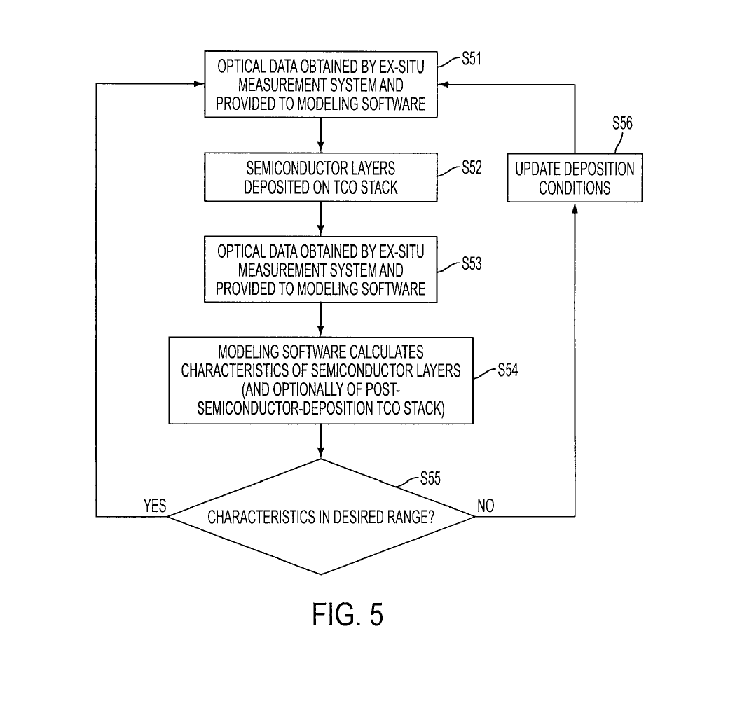

FIG. 5 is a flowchart showing the general method of operation of a portion of a photovoltaic device production system, namely the semiconductor layer deposition coater, optical measurement systems and optical modeling software package, in a production environment. In optional step S51, reflection and/or transmission data regarding the substrate with the TCO stack 125 deposited thereon is obtained by an ex-situ optical measurement system (e.g., optical measurement system 208) and reflection and/or transmission curves representing this data over a range of wavelengths are provided as inputs to an optical modeling software package (e.g., optical modeling software package 220). In step S52, the semiconductor layer(s) 120 are deposited on the TCO stack 125. In step S53, reflection and/or transmission data regarding the substrate with the TCO stack 125 and semiconductor layer(s) 120 deposited thereon is obtained by an ex-situ optical measurement system (e.g., optical measurement system 209) and reflection and/or transmission curves representing this data over a range of wavelengths are provided as inputs to the optical modeling software package. At step S54, the optical modeling software package uses these input reflection and/or transmission curves, along with input values for target thickness and optical constants of the layers, to determine the thicknesses of each of the semiconductor layer(s) 125. The thicknesses of the other layers of the stack and the optical constants of each of the layers may optionally also be calculated. At step S55, the calculated thicknesses for the semiconductor layers are compared to the target values for these layer thicknesses. If it is decided that the calculated thickness are sufficiently close to the target values (“Yes” at S55), the semiconductor layer(s) 120 are deposited on the next substrate and optical data is obtained therefor (step S51) and the process is repeated. If it is decided that the calculated thicknesses are not sufficiently close to the target values (“No” at S55), deposition conditions within the coater are updated to address the deviation (step S56) before the semiconductor layer(s) 120 are deposited on the next substrate.

The disclosed embodiments allow for in-line, real-time monitoring of the thicknesses of the semiconductor window and absorber layers 105, 106, based on optical data acquired by ex-situ optical measurement systems 208, 209. The disclosed embodiments also allow for in-line, real-time monitoring of variations in the thicknesses of the semiconductor layer(s) 120 in a single device or between and among several devices produced on the same line. The in-line measurement capabilities allow for quick detection of process excursions as well as in-line adjustment of the deposition parameters to ensure consistent production of the device. Additionally, the linkage of the two stacks (TCO stack 125 and device stack) in the modeling analysis, either by completing the modeling analysis for the TCO stack and semiconductor layers simultaneously or by using a separate modeling result of the TCO stack 125 (as described in the '______ application (F4500.1261)) as an input to the modeling analysis for the device stack, make the modeling of a multilayered device stack simpler and more reliable.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

What is claimed as new and desired to be protected by Letters Patent of the United States is:

1. A method of monitoring formation of a photovoltaic device comprising semiconductor layers formed on a substrate, the method comprising:
acquiring a first set of optical data from a first optical measurement system, the first set of optical data being at least one of transmission and reflection, collected at a plurality of wavelengths, of an optical signal passing through or reflected from a device stack, wherein the device stack comprises a substrate, a transparent conductive oxide layer and the semiconductor layers;
using the first set of optical data to determine at least one characteristic of the device stack.

2. The method of claim 1, wherein the first set of optical data is the transmission and the reflection, collected at a plurality of wavelengths, of the optical signal passing through and reflected from the device stack.

3. The method of claim 1, wherein the at least one characteristic of the device stack comprises a thickness of each of the semiconductor layers.

4. The method of claim 1, wherein the at least one characteristic of the device stack comprises at least one of a thickness, a refractive index value and an extinction coefficient of the transparent conductive oxide layer after deposition of the semiconductor layers.

5. The method of claim 1, wherein the photovoltaic device comprises a multilayered transparent conductive oxide stack, one of the layers being the transparent conductive oxide layer, and wherein the at least one characteristic of the device stack comprises at least one of a thickness, a refractive index value and an extinction coefficient of each layer of the transparent conductive oxide stack after deposition of the semiconductor layers.

6. The method of claim 1, wherein the first set of optical data is acquired in real-time with production of the photovoltaic device.

7. The method of claim 1, wherein the first optical measurement system is an ex-situ optical measurement system.

8. The method of claim 7, wherein the first optical measurement systems acquires optical data from a plurality of locations of the device stack.

9. The method of claim 8, wherein the first optical measurement system is mounted on a movable stage.

10. The method of claim 1, wherein the determining step is performed by an optical modeling software package stored on and operated by a computer system.

11. The method of claim 10, wherein the first set of optical data is provided as an input to the optical modeling software package.

12. The method of claim 11, wherein at least one of a thickness, a refractive index value and an extinction coefficient value of the transparent conductive oxide layer before deposition of the semiconductor layers are provided as inputs to the optical modeling software package.

13. The method of claim 12, wherein the at least one of a thickness, a refractive index value and an extinction coefficient value of the transparent conductive oxide layer before deposition of the semiconductor layers are an output of a separate modeling analysis regarding the transparent conductive oxide layer.

14. The method of claim 11, wherein an output of the optical modeling software package includes a thickness of each of the semiconductor layers.

15. The method of claim 12, wherein an output of the optical modeling software package includes a thickness of each of the semiconductor layers.

16. The method of claim 11, further comprising acquiring a second set of optical data from a second optical measurement system, the second set of optical data being at least one of transmission and reflection, collected at a plurality of wavelengths, of an optical signal passing through or reflected from a stack comprising the substrate and the transparent conductive oxide layer, and wherein the first and second sets of optical data are provided as inputs to the optical modeling software.

17. The method of claim 16, wherein an output of the optical modeling software package includes at least one of layer thickness, a refractive index value, and an extinction coefficient value of the transparent conductive oxide layer after semiconductor deposition and/or thicknesses of the semiconductor layers.

18. The method of claim 2, further comprising:
comparing the determined thickness of each of the semiconductor layers to a desired value of each thickness; and
adjusting deposition parameters of at least one of the semiconductor layers based on the comparing step.

19. A system for formation of a plurality of semiconductor layers of a photovoltaic device, the system comprising:
a plurality of deposition stages, each deposition stage configured to deposit one of the plurality of semiconductor layers;
a first ex-situ optical measurement system located after the plurality of deposition stages, the first ex-situ optical measurement system being for acquiring a first set of optical data regarding a device stack, the device stack comprising a substrate, a transparent conductive oxide layer and the plurality of semiconductor layers.

20. The system of claim 19, further comprising a cooling chamber positioned after the plurality of deposition stages and before the first ex-situ optical measurement system.

21. The system of claim 19, wherein the first set of optical data comprises at least one of transmission and reflection data, collected at a plurality of wavelengths, of the device stack.

22. The system of claim 19, further comprising conveyors for conveying a plurality of substrates onto which the plurality of semiconductor layers are to be deposited through the plurality of deposition zones.

23. The system of claim 21, further comprising an optical modeling software package stored on and operated by a computer, the optical modeling software package receiving the first set of optical data as an input.

24. The system of claim 23, wherein the optical modeling software causes the computer to output information regarding the device stack.

25. The system of claim 24, wherein the information regarding the device stack comprises at least one of layer thickness, a refractive index value, and an extinction coefficient value of the transparent conductive oxide layer after semiconductor deposition and/or thicknesses of the semiconductor layers.

26. The system of claim 23, wherein the optical modeling software package receives information regarding the transparent conductive oxide layer before semiconductor deposition as an input.

27. The system of claim 26, wherein the information regarding the transparent conductive oxide layer before semiconductor deposition provided as an input is an output of a separate optical modeling software package conducting modeling analysis regarding the transparent conductive oxide layer before semiconductor deposition.

28. The system of claim 21, further comprising a second ex-situ optical measurement system located before the plurality of deposition stages, the second ex-situ optical measurement system being for acquiring a second set of optical data regarding a stack comprising the substrate and the transparent conductive oxide layer of the photovoltaic device, wherein the second set of optical data comprises at least one of transmission and reflection data, collected at a plurality of wavelengths, of the stack comprising the substrate and the transparent conductive oxide layer.

29. The system of claim 28, further comprising an optical modeling software package stored on and operated by a computer, the optical modeling software package receiving the first and second sets of optical data as inputs.

30. The system of claim 28, wherein the optical modeling software causes the computer to output information regarding the device stack.
